(19) United States
(12) Patent Application Publication
(10) Pub. No.: US 2016/0275631 A1
(43) Pub. Date: Sep. 22, 2016

(54) ORDER SYSTEM

(71) Applicant: TOSHIBA TEC KABUSHIKI KAISHA, Tokyo (JP)

(72) Inventor: Yasutoshi Serizawa, Izu (JP)

(21) Appl. No.: 14/662,430

(22) Filed: Mar. 19, 2015

(51) Int. Cl. G06Q 50/12; G06Q 10/02

(52) U.S. Cl. CPC G06Q 50/12; G06Q 10/02

(57) ABSTRACT

An order system comprises a ticket machine which receives a seat designation input, acquires seat information for identifying the seat, issues a data transmission medium recording the seat information, and sends the seat information; multiple seat units which read the seat information recorded in the data transmission medium, and control, if first information sent based on the seat information is received and it is detected that a user is seated, to give a notification indicating that the seat cannot be used if it is confirmed that the seat information based on the information of the data transmission medium is not consistent with the seat unit of its own; and a server which receives the seat information from the ticket machine, and sends the first information to the seat unit corresponding to the seat information.

### FIELD

Embodiments described herein relate generally to a system for ordering a dish in, for example, a food court.

### BACKGROUND

There is a food court serving as a public place in a commercial facility where incoming customers can eat, drink or rest.

There is a problem in the food court that a seat cannot be guaranteed in a case of a full house for the customer who already ordered a dish and finished the settlement.

### DESCRIPTION OF THE DRAWINGS

FIG. 1 is a diagram illustrating an example of the constitution of an order system according to one embodiment;

FIG. 2 is a block diagram illustrating an example of the constitution of a server according to the embodiment;

FIG. 3 is a block diagram illustrating an example of the constitution of a ticket machine according to the embodiment;

FIG. 4 is a block diagram illustrating an example of the constitution of a seat according to the embodiment;

FIG. 5A is a diagram illustrating an example of an order screen displayed on the ticket machine according to the embodiment;

FIG. 5B is a diagram illustrating an example of a seat availability state displayed on the ticket machine according to the embodiment;

FIG. 6 is a diagram illustrating an example of a correspondence table which is stored in a management DB and stores a tag ID, a seat number and an order ID in an associated manner;

FIG. 7 is a diagram illustrating an example of a correspondence table which is stored in the management DB and stores an order ID and order content in an associated manner;

FIG. 8 is a diagram illustrating an example of a correspondence table which is stored in the management DB and stores a seat number and a state flag in an associated manner;

FIG. 9 is a flowchart illustrating an example of the operation of a meal ticket machine according to the embodiment;

FIG. 10 is a flowchart illustrating an example of the operation of the server according to the embodiment;

FIG. 11 is a flowchart illustrating an example of the operation of the seat according to the embodiment;

FIG. 12 is a flowchart illustrating an example of the operation of the server when an ordered dish is prepared; and

FIG. 13 is a flowchart illustrating an example of the operation of the seat when the ordered dish is prepared.

### DETAILED DESCRIPTION

In accordance with one embodiment, an order system comprises a ticket machine, a plurality of seat units and a server. The ticket machine receives a seat designation input, acquires seat information for identifying the designated seat, issues a data transmission medium in which the seat information is recorded, and then sends the seat information. The seat unit includes a reading section which reads the information recorded in the data transmission medium, a notification section which notifies the seat state, a detection section which detects whether or not a user is seated, and a control section which controls, in a case in which first information sent on the basis of the seat information is received and the detection section detects that a user is seated, the notification section to give a notification indicating that the seat cannot be used if it is confirmed that the seat information based on the information read by the reading section is not consistent with the seat unit of its own. The server receives the seat information from the ticket machine, and sends the first information to the seat unit corresponding to the seat information.

The order system according to the embodiment is also used as a system for reserving a seat of, for example, a food court in a commercial facility. In the order system according to the embodiment, the ticket machine displays a screen indicating the state of seats when an incoming customer purchased a meal ticket from the ticket machine, or when the incoming customer already ordered a dish and finished the settlement. The incoming customer selects an empty seat according to the seat state screen to reserve the seat. The ticket machine issues a contactless-type IC card associated with the reserved seat.

The table of each seat is equipped with a card reader and an indicator indicating that the table is reserved on the surface thereof. The incoming customer goes over to the reserved seat according to the turning-on of the indicator and holds the issued card over the card reader of the table. Through such an operation, the seat is managed as an in-use state.

If the incoming customer is seated in a state in which the seat is reserved and the card associated with the seat is not held over the card reader, the speaker arranged in the table activates a warning buzzer. In this way, the incoming customer can be aware that the seat is already reserved and gives up the seat to the customer who reserved the seat.

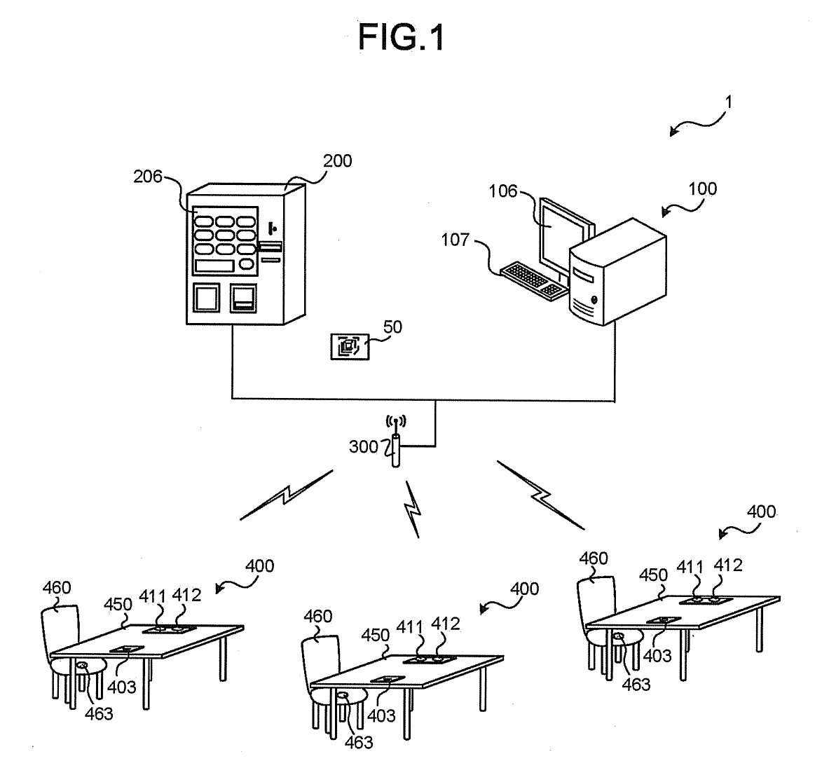

Hereinafter, the embodiment is described with reference to the accompanying drawings. FIG. 1 is a schematic view illustrating an example of the constitution of the order system according to the embodiment. The order system 1 according to the embodiment is equipped with a server 100, a ticket machine 200, an access point 300 and a plurality of seats 400 (seat unit) which communicate with each other through a network.

The server 100 is a computer for managing data such as order content and the reservation state of the seat. The ticket machine 200 receives the order from the incoming customer and receives the payment of the fee to carry out settlement. The ticket machine 200 further receives the reservation of seat from the incoming customer and issues a card 50 associated with the reserved seat. The card 50 is a contactless-type IC (Integrated Circuit) card that can be rewritten through a later-described card writer 207. The card 50 exchanges information with a later-described card reader 403 through a near-field wireless communication from an RF tag containing ID information.

The access point 300 is a wireless device for carrying out data transmission between the server 100 and the seat 400. The access point 300 receives data from the seat 400 through the wireless communication and transmits the received data to the server 100 through wired or wireless communication. The access point 300 also receives data from the server 100 and transmits the received data to the seat 400 serving as a transmission destination.

The seat 400 includes a table 450 and one or a plurality of chairs 460. On the upper surface of the table 450 are arranged a reservation indicator 411 and an in-use indicator 412. The reservation indicator 411 is turned on if the seat 400 is reserved and turned off if the seat 400 is being used or empty. The in-use indicator 412 is turned on if the seat 400 is being used; otherwise, the in-use indicator 412 is turned off. On the upper surface of the table 450 is further arranged a card reader 403 which reads the information of the card 50 when the card 50 is held over it.

The chair 460 is equipped with a sensor 463 for detecting the seating of the incoming customer. In the present embodiment, the sensor 463 is arranged at the upper surface of the seat. The chair 460 and the table 450 include a wireless communication module respectively, and a detection signal is output to the table 450 if the sensor 463 detects the seating of the incoming customer.

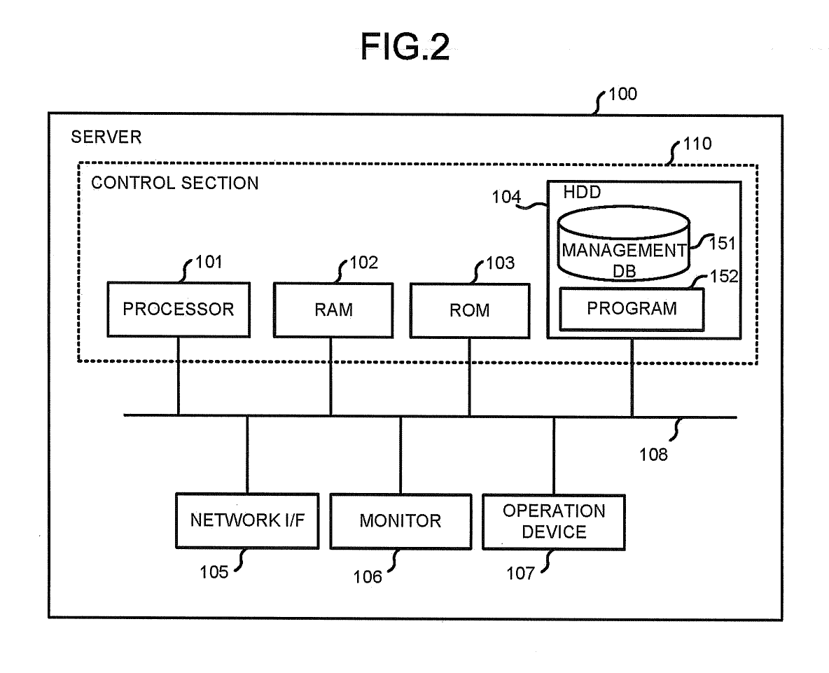

FIG. 2 is a block diagram illustrating an example of the constitution of the server 100. The server 100, which is a computer, includes a processor 101, an RAM (Random Access Memory) 102, an ROM (Read Only Memory) 103, an HDD (Hard Disk Drive) 104, a network I/F (Interface) 105, a monitor 106 and an operation device 107 which input and output data or signals with each other through a bus line 108. The processor 101, the RAM 102, the ROM 103, the HDD 104 and the bus line 108 which is used by each unit to input and output data or signals constitute a control section 110.

The processor 101 is an arithmetic device such as a CPU (Central Processing Unit) and the like. The processor 101 copies or decompresses a program stored in the ROM 103 or a program 152 stored in the HDD 104 on the RAM 102 to execute it, thereby providing various functions while cooperating with each hardware. The RAM 102 is a main storage device, and the ROM 103 is a nonvolatile storage device for storing system programs and the like.

The HDD 104 is a nonvolatile auxiliary storage device for storing programs and data. The network I/F 105 equipped with an LAN (Local Area Network) board controls the communication of the data received by the server 100 from an external device and the data to be sent to the external device by the server 100.

The monitor 106 and the operation device 107 (for example, keyboard and mouse) mainly serve as operation display sections when a manager of the server 100 and the like carries out the maintenance.

A management DB (Database) 151 is constituted and the program 152 is stored in HDD 104 in advance.

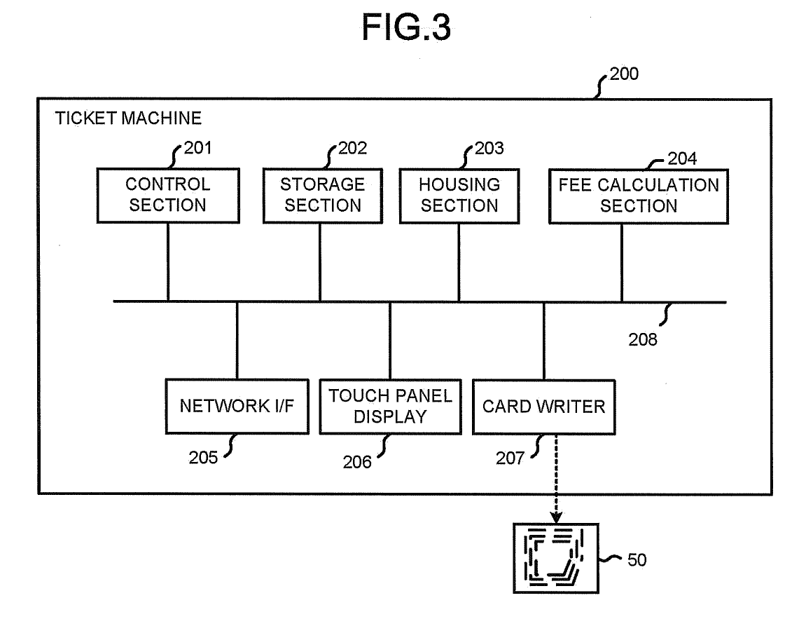

FIG. 3 is a block diagram illustrating an example of the constitution of the ticket machine 200. The ticket machine 200 includes a control section 201, a storage section 202, a housing section 203, a fee calculation section 204, a network I/F 205, a touch panel display 206 and a card writer 207 which input and output data or signals with each other through a bus line 208.

The control section 201 executes a program stored in the storage section 202 to control the operation of each hardware in the ticket machine 200. The storage section 202 stores a control program and data used in processing. The storage section 202 further stores, for example, a screen image displayed on the touch panel display 206, the correspondence relationship between the seat state screen for display and a seat number, and various kinds of information such as identification information and fee information of the dish. The housing section 203 includes a unit which houses deposited bills and coins. The housing section 203 further includes a cash depositing mechanism and a cash dispensing mechanism. The fee calculation section 204 is an ASIC (Application specific integrated circuit) which calculates a difference and the change on the basis of the ordered dish and the deposited amount.

The network I/F 205 equipped with an LAN (Local Area Network) board controls the communication with the external device. The touch panel display 206, which is a user interface constituted by laminating a touch panel on a flat type liquid crystal display, receives the dish selection, the seat reservation and the like from the incoming customer. The card writer 207 writes information in the card 50. The information mentioned herein includes at least an order ID output when the dish is ordered, and a table number of the reserved table. The card 50 further stores a tag ID as the identification information thereof.

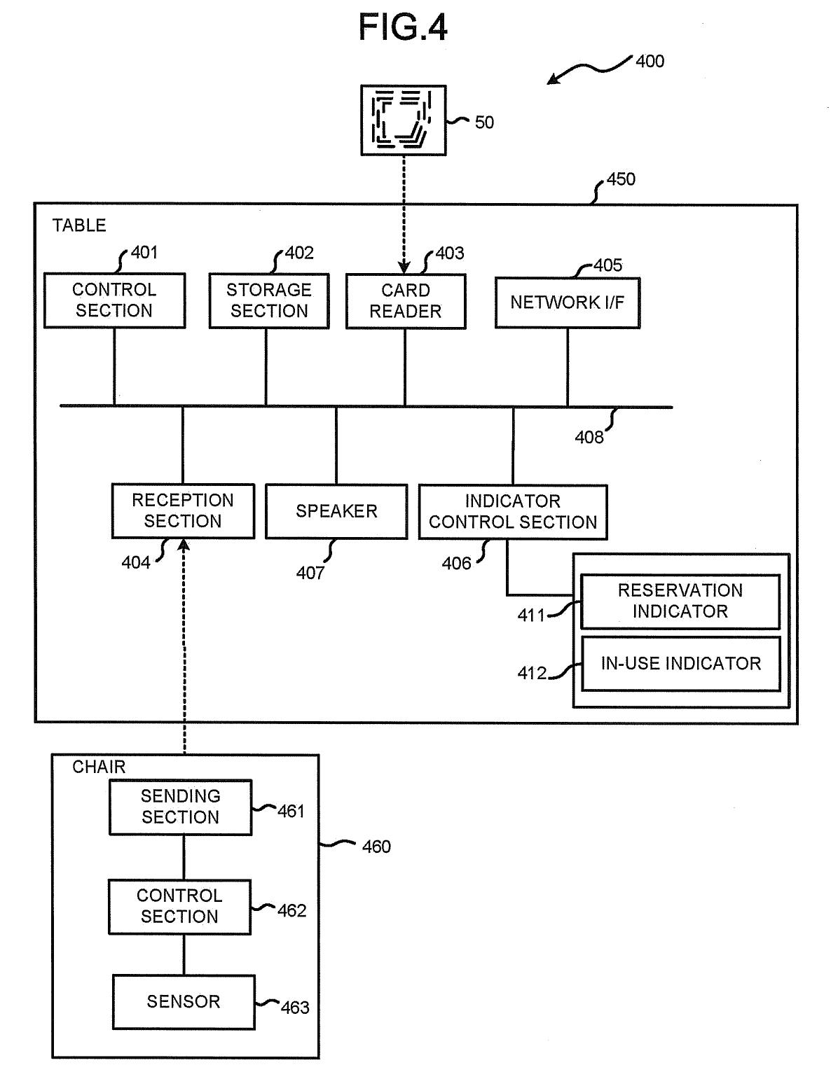

Next, an example of the constitution of the seat 400 is described with reference to FIG. 4. The seat 400 includes the table 450 and the chair 460. The table 450 includes a control section 401, a storage section 402, the card reader 403, a reception section 404, a network I/F 405, an indicator control section 406 and a speaker 407 which are connected with each other through a bus line 408.

The control section 401 executes programs stored in the storage section 402 to uniformly control each hardware contained in the table 450 shown in FIG. 4. The storage section 402 stores an operation control program and necessary data in a volatile/nonvolatile manner. The card reader 403 reads the information stored in the card 50. The read information is stored in the storage section 402. The reception section 404, a reception section based on a near-field wireless communication standard, receives a sensor detection signal from the chair 460. The indicator control section 406 controls the turning-on of the reservation indicator 411 and the in-use indicator 412. The speaker 407, which includes a power amp and a controller, issues a sound or voice if, for example, a customer other than the incoming customer that made the reservation is seated in the reversed seat.

The chair 460 includes a sending section 461, a control section 462 and the sensor 463. The sensor 463 is, for example, an infrared ray sensor for detecting whether or not a person is seated in the chair. The control section 462 controls the sending section 461 and the sensor 463, and converts the signal from the sensor 463 into a digital signal and then outputs the digital signal to the sending section 461. The sending section 461 sends the signal information detected by the sensor 463 to the reception section 404 of the table 450 according to the near-field wireless communication standard. In addition, the sending section 461 of the chair 460 and the reception section 404 of the table 450, which are associated with each other through pairing and the like in advance, can carry out communication only between the chair 460 and the table 450 that are associated. On the contrary, the communication between the chair 460 and the table 450 that are not associated is not allowed.

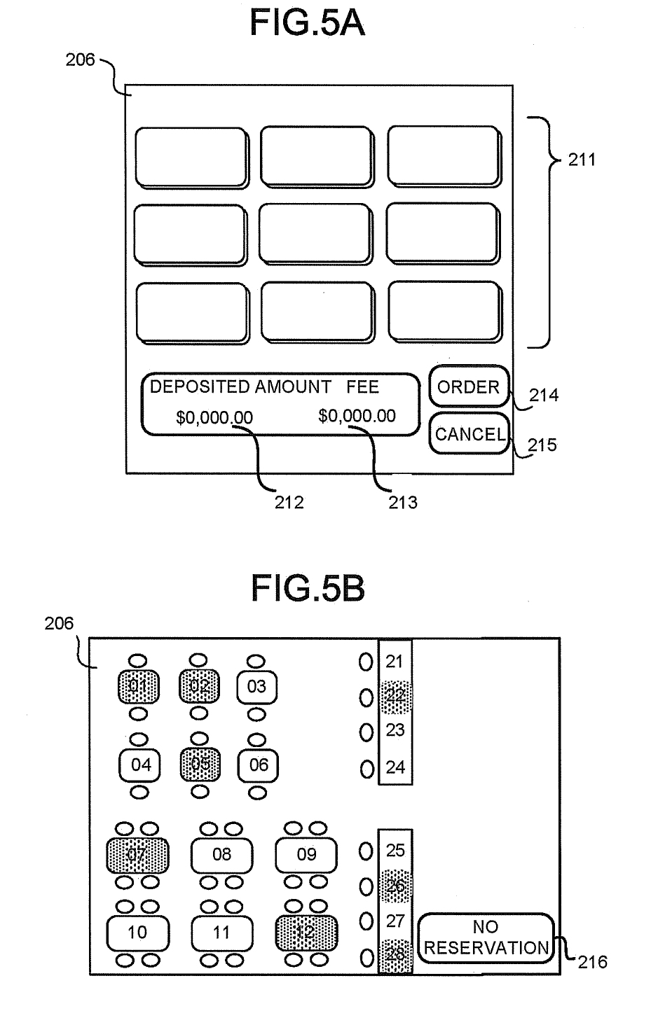

FIG. 5A is a diagram illustrating an example of the display of the ticket machine 200 when the incoming customer selects and orders a dish. The ticket machine 200, if receiving a pre-determined operation from the incoming customer, displays an order screen shown in FIG. 5A on the touch panel display 206. The order screen includes dish menu buttons 211, a deposited amount column 212 for displaying the amount deposited from the incoming customer and a fee column 213 for displaying the total amount of the ordered dishes. The incoming customer presses the dish menu button 211 to select the dish he/she wants to order, and the total amount of the ordered dishes is displayed in the fee column 213.

If an order button 214 is pressed, the control section 210 determines the order, and the fee calculation section 204 calculates the difference amount (change) between the deposited amount and the total amount. The ticket machine 200 dispenses the change to a cash dispensing try of the housing section 203 if there is change. If a cancel button 215 is pressed, the control section 201 cancels all the processing, and returns the deposited amount to the incoming customer through the cash dispensing try.

If the order button 214 is pressed, the control section 201 outputs the order ID and stores it in the storage section 202 in association with the order content (the identification number and the quantity of the dish in the present example). The output of the order ID may be carried out by the server 100.

Sequentially, the control section 201 displays a seat reservation screen shown in FIG. 5B on the touch panel display 206. The seat reservation screen refers to the image data indicating the layout of the seats in the food court. The incoming customer designates the seat number displayed on the seat reservation screen to reserve the seat. In the example shown in FIG. 5B, shaded areas indicate the seats that are reserved or being used, and non-shaded areas indicate the seats that are empty. When the incoming customer designates the empty seat to make a reservation, the control section 201 controls the card writer 207 to write the seat number of the reserved seat and the order ID stored in the storage section 202 in the card 50, and then issues the card 50 to a tray. The control section 201 further controls the network I/F 205 to send the seat number of the reserved seat, the order ID, the order content and the identification information (tag ID) of the card 50 to the server 100.

If a button 216 shown in FIG. 5B is pressed, the reservation of the seat is not made. In this case, the control section 201 writes the order ID in the card 50 and sends the order ID, the order content and the tag ID to the server 100. At this time, the seat number of the reserved seat is not sent; alternatively, a number indicating that no reservation is made is sent to the server 100 together with the information mentioned.

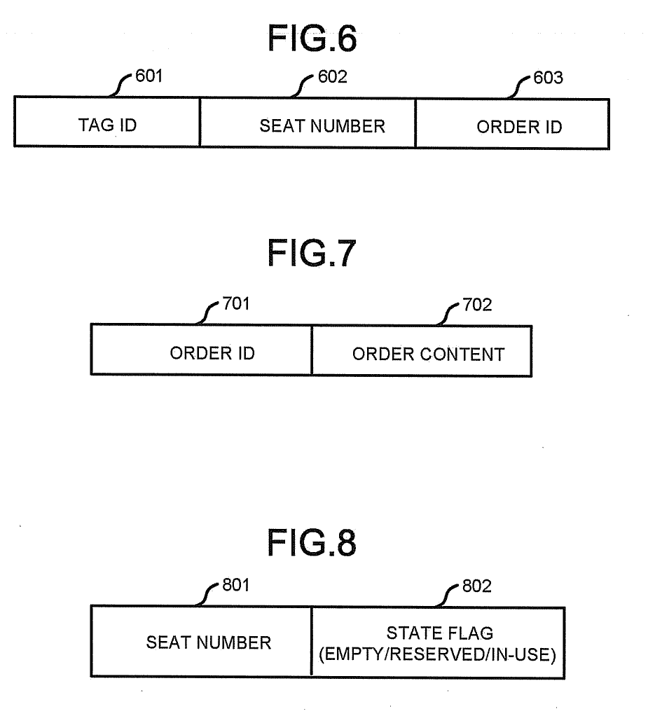

FIG. 6, FIG. 7 and FIG. 8 are diagrams illustrating one example of various correspondence tables managed by the management DB151 of the server 100. FIG. 6 is a diagram illustrating a correspondence table which stores a tag ID column 601, a seat number column 602 and an order ID column 603 in an associated manner. FIG. 7 is a diagram illustrating a correspondence table which stores an order ID column 701 and an order content column 702 in an associated manner. The control section 110 of the server 100 receives the seat number of the reserved seat, the order ID, the order content, the tag ID from the ticket machine 200 and writes the received information in the correspondence tables shown in FIG. 6 and FIG. 7.

FIG. 8 is a diagram illustrating a correspondence table which stores a seat number column 801 and a state flag column 802 in an associated manner. The state flag column 802 stores the state of the seat in the form of a flag value. In this example, three states of “empty state”, “reserved state” and “in-use state” are stored as the state flag for each seat number. The “empty state” is an initial state; and the flag value changes if the following conditions are met.
1) If the seat number of the reserved seat is received from the ticket machine 200, the seat with the seat number is turned into the “reserved state”.
2) If the card reader 403 of the seat 400 reads the information of the card 50 in the “empty state” or the “reserved state”, the seat is turned into the “in-use state”. The seat is turned into the “in-use state” from the “empty state” when the button 216 shown in FIG. 5B is pressed and the seat is not reserved or when the incoming customer sits in the chair only for rest without ordering anything.
3) When a signal is output from the sensor 463 in the “empty state”, the seat is turned into the “in-use state”.
4) When no signal is output from the sensor 463 of the chair 460 in a pre-determined period in the “in-use state”, the seat is considered to be empty and is therefore turned into the “empty state”.
5) Even if a signal is output from the sensor 463 while the information of the card 50 associated with the seat 400 is not read in the “reserved state”, the seat is still kept in the “reserved state”. In this case, the seat 400 determines that the seated customer is not the customer who reserved the seat, and activates a warning buzzer through the speaker 407.

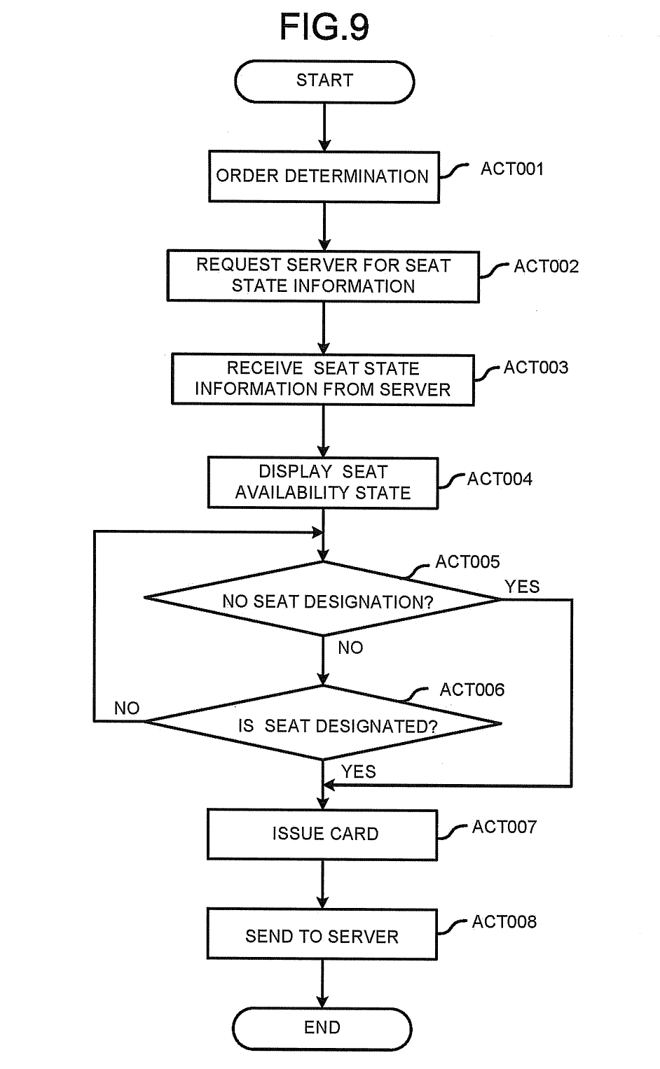

FIG. 9 is a flowchart illustrating an example of the operation of the meal ticket machine 200. If the order button 214 on the order screen shown in FIG. 5A is pressed, the control section 201 determines the order of the dish and stores the order ID and the order content in the storage section 202 (ACT 001). The control section 201 requests the server 100 for the seat state information through the network I/F 205 (ACT 002), and receives the seat state information (ACT 003). The seat state information is the data of the pair of the state flag and the seat 400 shown in FIG. 8. The control section 201 displays the seat reservation screen shown in FIG. 5B on the touch panel display 206 based on the received seat state information (ACT 004).

If the button 216 (refer to FIG. 5B) on the seat reservation screen is not pressed (NO in ACT 005), and the seat number (seat information) in the “empty state” is designated (YES in ACT 006), the control section 201 carries out a control to issue the card 50 (ACT 007). The control section 201 writes the seat number and the order ID in the card 50 and then issues the card 50 to the tray. Even if the button 216 is pressed (YES in ACT 005), the control section 201 still carries out a control to issue the card 50 (ACT 007). In this case, the control section 201 only writes the order ID in the card 50 and then issues the card 50.

The control section 201 sends the order ID, the order content and the tag ID serving as the identification information of the card 50 to the server 100 through the network I/F 205, or sends the seat number if there is a seat reservation (ACT 008).

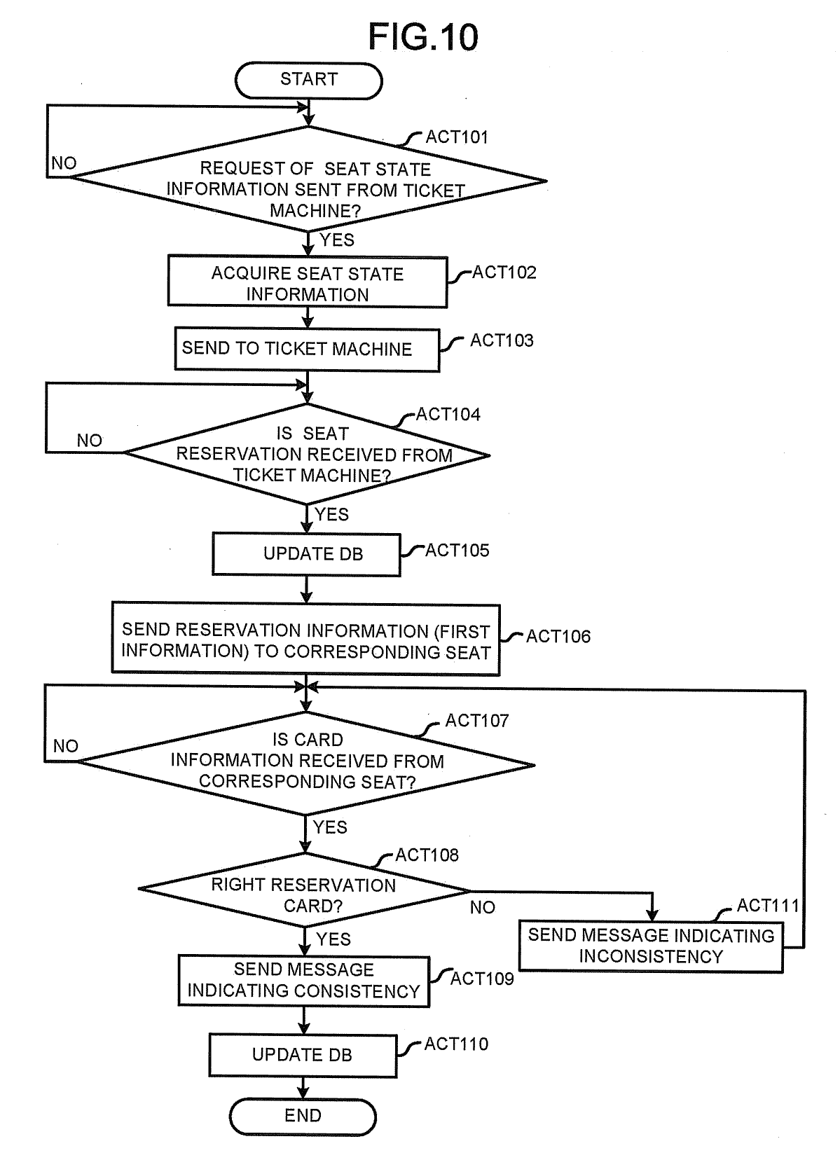

FIG. 10 is a flowchart illustrating an example of the operation of the server 100. The control section 110 waits until the request of the seat state information sent from the ticket machine 200 is received (loop of NO in ACT 101). If the request of the seat state information is received (YES in ACT 101), the control section 110 acquires the seat state information (refer to FIG. 8) from the management DB151 (ACT 102), and then sends the acquired seat state information to the ticket machine 200 (ACT 103).

The control section 110, if receiving the order ID, the order content and the tag ID or receiving the seat number when there is a seat reservation from the ticket machine 200 (YES in ACT 104), updates the correspondence table shown in FIG. 6 and FIG. 7, and changes the state flag of the seat 400 shown in FIG. 8 from the “empty state” to the “reserved state” (ACT 105).

The control section 110 controls the network I/F 105 to send reservation information (first information) indicating that the seat is reserved to the seat 400 (ACT 106), and waits until the information of the card 50 is received from the seat 400 (loop of NO in ACT 107). If the information of the card 50 is received from the seat 400 (YES in ACT 107), the control section 110 determines whether or not the pair of the received tag ID and the seat number is registered in the correspondence table shown in FIG. 6 to determine whether or not it is the right reservation card (ACT 108). If it is not the right reservation card (NO in ACT 108), the control section 110 controls the network I/F 105 to reply a message indicating the inconsistency to the seat 400 serving as a sending source (ACT 111). Sequentially, the control section 110 returns to execute the processing in ACT 107. On the other hand, if it is the right reservation card (YES in ACT 108), the control section 110 replies a message indicating the consistency to the seat 400 serving as a sending source (ACT 109). Then, the control section 110 changes the state flag of the seat 400 shown in FIG. 8 from the “reserved state” to the “in-use state” (ACT 110).

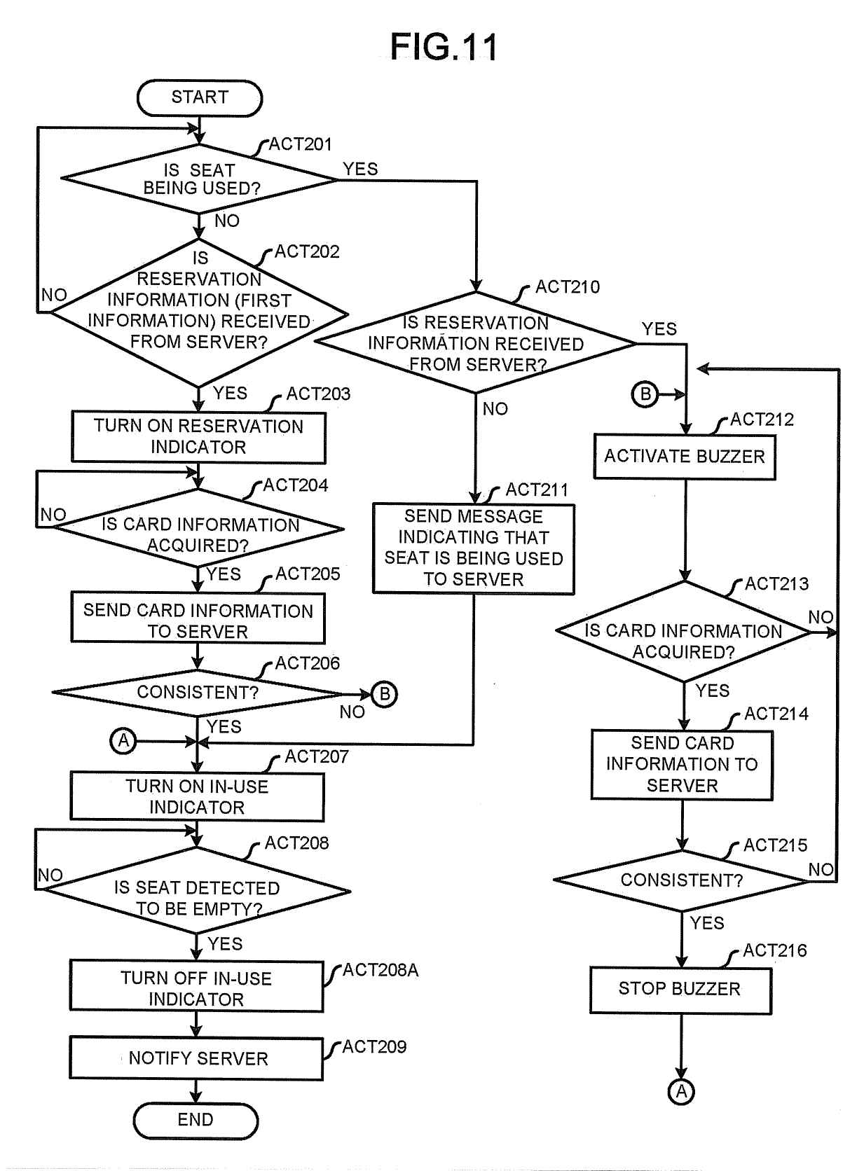

FIG. 11 is a flowchart illustrating an example of the operation of the seat 400. The control section 401 of the table 450, if receiving the seating detection signal from the chair 460 (YES in ACT 201), determines whether or not the seat is reserved (ACT 210). The determination is carried out with reference to the status of its own if the status of its own is stored in the storage section 402, or through an inquiry to the server 100. If the seat is reserved (YES in ACT 210), the control section 401 controls the speaker 407 to activate the warning buzzer (ACT 212). The buzzer is activated continuously until the card 50 is held over the card reader 403 and the card information (tag ID, seat number and order ID) stored in the card 50 is acquired (loop of NO in ACT 213). The control section 401, if acquiring the card information (YES in ACT 213), sends the card information to the server 100 (ACT 214).

If the reply from the server 100 is the message indicating the consistency (YES in ACT 215), the control section 401 controls the speaker 407 to stop the buzzer (ACT 216), and then carries out the processing in ACT 207. If the reply from the server 100 is the message indicating the inconsistency (NO in ACT 215), the processing in ACT 212 is carried out to continue activating the buzzer.

If the seat is not reserved (NO in ACT 210), it is regarded that the seat 400 is in the empty state, and the control section 401 sends a message indicating that the seat is being used to the server 100 (ACT 211), and then carries out the processing in ACT 207. The control section 110 of the server 100, if receiving the message indicating the in-use state, changes the correspondence table shown in FIG. 8 from the “empty state” to the “in-use state”.

If no detection signal is received from the chair 460 (NO in ACT 201), and if the reservation information (first information) is received from the server 100 (YES in ACT 202), the control section 401 instructs the indicator control section 406 to turn on the reservation indicator 411 (ACT 203).

The control section 401, if acquiring the card information when the incoming customer arrives at the reserved seat 400 and holds the card 50 over the card reader 403 (YES in ACT 204), sends the card information to the server 100 through the network I/F 405 (ACT 205). If the reply from the server 100 is the message indicating the inconsistency (NO in ACT 206), the processing in ACT 212 is carried out, and the control section 401 controls the speaker 407 to activate the buzzer. If the reply from the server 100 is the message indicating the consistency (YES in ACT 206), the control section 401 instructs the indicator control section 406 to turn on the in-use indicator 412 (ACT 207). At this time, if the reservation indicator 411 is in a turned-on state, the control section 401 turns off the reservation indicator 411.

After the incoming customer finishes dining, and the detection signal from the chair 460 is stopped (YES in ACT 208), the control section 401 turns off the in-use indicator 412 (ACT 208A), and sends a message indicating that the seat is in the empty state to the server 100 (ACT 209). The server 100, if receiving the message, changes the state flag of the table shown in FIG. 8 from the “in-use state” to the “empty state”.

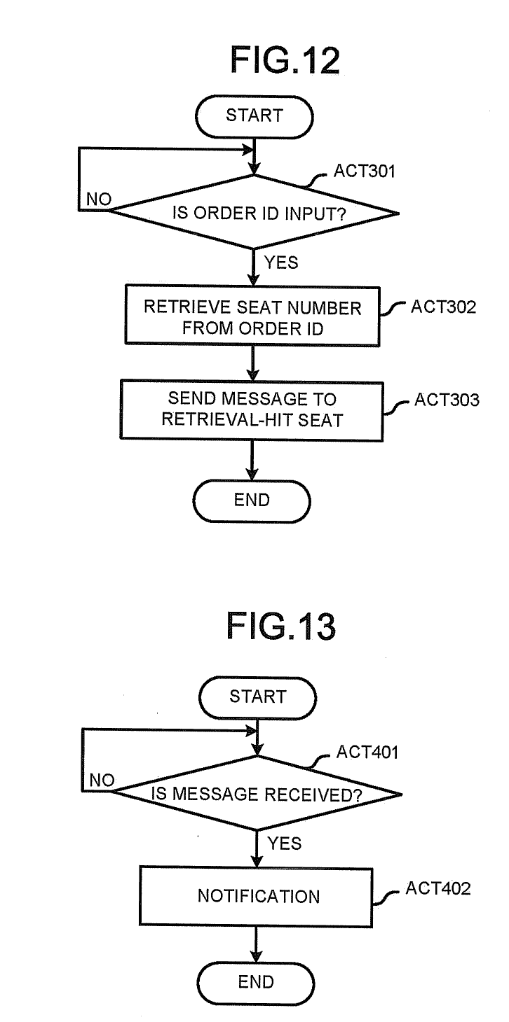

Further, since the seat number and the order ID are associated with each other as shown in FIG. 6, it is also applicable to notify the seat 400 as soon as the ordered dish is prepared. In this case, a voice or sound indicating that the ordered dish is prepared may be issued through the speaker 407. In such a constitution, an example of the operation of the server 100 is shown in FIG. 12 and an example of the operation of the seat 400 is shown in FIG. 13. The control section 110 of the server 100 determines whether or not the order ID is input from, for example, an external device (not shown) or the operation device 107 (ACT 301). If the order ID is input (YES in ACT 301), the control section 110 retrieves the seat number associated with the order ID based on the correspondence table shown in FIG. 6 (ACT 302), and then sends a message indicating that the ordered dish is prepared to the retrieval-hit seat 400 (ACT 303).

Next, the flowchart in FIG. 13 is described. The control section 401 of the seat 400 waits until the message sent in ACT 303 is received (loop of NO in ACT 401). If the message is received (YES in ACT 401), the control section 401 controls the speaker 407 to issue a voice or sound indicating that the ordered dish is prepared (ACT 402).

In the present embodiment, the determination on whether or not the seat is empty or whether or not the seat is reserved is carried out at a unit of “seat” serving as a set of chair and table; however, it is not limited to this. The determination may be carried out at a unit of chair or table.

It is exemplified in the present embodiment that the reservation of the seat is made after the determination of the order; however, the sequence is not limited to this. For example, the order may be received after the reservation of the seat is made. Alternatively, the order is determined after the card 50 is held over the card reader 403 of the seat 400.

In the present embodiment, the card is exemplified as a data transmission medium in which the seat information is recorded; however, it is not limited to this. The data transmission medium may be a tag or receipt on which a barcode or a two-dimensional code obtained by coding the seat information is printed, or a portable communication terminal (for example, a smart phone) of the user that receives the barcode or the two-dimensional code.

In the embodiment described above, the functions for implementing various embodiments are pre-recorded in the apparatus. However, the present invention is not limited to this; the same functions may be downloaded to the apparatus from a network. Alternatively, the same functions recorded in a recording medium may be installed in the apparatus. The form of the recording medium is not limited as long as the recording medium can store programs in a CD-ROM and is readable by an apparatus. Further, the functions realized by a pre-installed or pre-downloaded program can also be realized through the cooperation with an OS (Operating System) installed in the apparatus.

In accordance with the embodiment, the incoming customer who reserved a seat regularly can be provided with a seat, and it can be prevented that there is no seat in spite of the order.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An order system comprising:
a ticket machine configured to receive a seat designation input, acquire seat information for identifying the designated seat, issue a data transmission medium in which the seat information is recorded, and then send the seat information;
a plurality of seat units configured to include a reading section which reads the information recorded in the data transmission medium, a notification section which notifies the seat state, a detection section which detects whether or not a user is seated, and a control section which controls, in a case in which first information sent on the basis of the seat information is received and the detection section detects that a user is seated, the notification section to give a notification indicating that the seat cannot be used if it is confirmed that the seat information based on the information read by the reading section is not consistent with the seat unit of its own; and
a server configured to receive the seat information from the ticket machine, and send the first information to the seat unit corresponding to the seat information.

2. The order system according to claim 1, wherein
the seat unit further includes a light emitting section which emits light if the first information is received.

3. The order system according to claim 1, wherein
the control section of the seat unit controls the notification section not to give a notification indicating that the seat cannot be used if the detection section detects that a user is seated while the first information is not received.

4. The order system according to claim 1, wherein
the server stores the seat information and a state value indicating whether the seat unit is in an empty state or a reserved state in a storage section in an associated manner; and
if the seat information is received from the ticket machine, the state value associated with the seat information is changed from the empty state to the reserved state.

5. The order system according to claim 4, wherein
the server sends information which is stored in the storage section and associates the seat information with the state value to the ticket machine; and
the ticket machine receives the information which associates the seat information with the state value from the server, and displays, based on the information, a screen which shows the arrangement of the seat units so that the user can be aware of the state of each seat unit.

6. The order system according to claim 4, wherein
the control section of the seat unit controls to send second information indicating that the seat is being used to the server if the detection section detects that a user is seated and the first information is not received; and
the server further stores a state value indicating whether or not the seat is in an in-use state in association with the seat information, and changes, if receiving the second information, the state value of the seat information corresponding to the seat unit that sends the second information from the empty state to the in-use state.

7. The order system according to claim 6, wherein
the seat unit further includes a light emitting section which emits light if the detection section detects that a user is seated and the first information is not received.

8. The order system according to claim 6, wherein
the control section of the seat sends third information indicating that the seat is turned into the empty state to the server if the detection section of the seat unit detects that the user is no longer seated; and
the server changes, if receiving the third information, the state value of the seat information corresponding to the seat unit that sends the third information from the in-use state to the empty state.

9. The order system according to claim 1, wherein
the data transmission medium stores identification information of its own;
the ticket machine sends the identification information of the data transmission medium and the seat information to the server in an associated manner;
the server stores the sent seat information and the identification information of the data transmission medium in the storage section in an associated manner; and
the control section of the seat unit controls the notification section not to give the notification indicating that the seat cannot be used if the seat information and the identification information of the data transmission medium read by the reading section is consistent with the seat information and the identification information of the data transmission medium stored in the server.

10. The order system according to claim 1, wherein
the ticket machine further receives an order from the user and sends the seat information and identification information of the order to the server;
the server stores the seat information and the identification information of the order in the storage section in an associated manner, and sends, if the identification information of the order is input, fourth information to the corresponding seat unit based on the correspondence between the seat information and the identification information of the order stored in the storage section; and
the notification section of the seat unit further gives a notification indicating that the ordered dish is prepared if the fourth information is received.
